(19) United States
(12) Patent Application Publication
(10) Pub. No.: US 2003/0135480 A1
(43) Pub. Date: Jul. 17, 2003

(54) System for updating a database

(76) Inventors: Robert S. Van Arsdale, West Chester, PA (US); David G. Parrish, Downingtown, PA (US); Michael E. Tellup, Havre De Grace, MD (US)

Correspondence Address: Siemens Corporation, Intellectual Property Department, 186 Wood Avenue South, Iselin, NJ, 08830, US

(21) Appl. No.: 10/308,686

(22) Filed: Dec. 3, 2002

Related U.S. Application Data
(60) Provisional application No. 60/348,936, filed on Jan. 14, 2002.

(51) Int. Cl. G06F 7/00

(52) U.S. Cl. 707/1

(57) ABSTRACT

A method converts data in a database from a current value to a different replacement value. The method receives information identifying a database data field to be updated and data including a current value and a corresponding replacement value for replacing existing data in the identified data field. The method examines the database to determine whether the data field is associated with a trigger for initiating amendment of a database element upon alteration of the data field content, and/or an index used for locating said data field. The method disables a trigger and an index when identified by the examination. The method replaces existing data in the data field with the received replacement value. The method verifies successful replacement of the data field current value.

### CROSS-REFERENCE TO RELATED APPLICATIONS

The present application is a non-provisional application of provisional application having serial No. 60/348,936 filed by Robert VanArsdale on Jan. 14, 2002.

### FIELD OF THE INVENTION

The present invention generally relates to a process of updating information stored in a data processing system. More particularly, the present invention relates to a system for updating a database and a user interface and method therefor.

### BACKGROUND OF THE INVENTION

Computers are very powerful tools for storing and providing access to vast amounts of information. Computer databases are a common mechanism for storing information in the form of a database on computer systems while providing easy access to users. The size of a database may be several megabytes to several gigabytes or more, depending on the application. A typical database is a predetermined, organized collection of related information stored as “records” having “fields” or “attributes” of information, which may be viewed as “tables” of records.

For example, a database of healthcare patients may have a record for each patient where each record contains fields designating specifics about the patient, such as name, home address, attending doctor, name of the healthcare enterprise, and the like. The particular values entered in the field of a table for a given patient constitute records of that table. In many applications, tables are continuously updated as records are inserted, deleted, or modified during normal operation of the database. A database management system (DBMS) is used to manage these updates as well as other database operations, such as query processing, evaluation and optimization. Examples of conventional DBMSs include DB2, Informix, Ingres, and Microsoft SQL Server, as well as others from Oracle, Sybase, and Teradata.

Sometimes it is necessary to convert a field in a database from one value to another by searching all the current database tables for an occurrence of the field. For example, in the database of healthcare patients the name of the attending doctor for many patients may need to be changed when a doctor leaves a medical practice or when two medical practices merge.

Typically, the conversion of a field present in many tables is a very difficult and cumbersome procedure. The conversion may be performed manually or semi-automatically. Manual conversion requires a user to identify all the tables the field is in, any variations of the field name, and any fields that have the same data type. The manual conversion process is time consuming and fields could be missed due to human error. Semi-automatic conversion requires a programmer to write SQL code to replace the manual conversion process. The semi-automatic conversion may be performed by using SQL code to perform an “update table . . . set column=“newval” where column=“oldval” for each change needed,” as is well known to those skilled in the relevant art. A disadvantage of the SQL code approach is that the code needs to be written for each table that needed to be changed, and if more than one value would need to be changed within the field, the SQL would have to be run many times. The SQL code approach also requires the user to be very familiar with SQL programming language, and to understand all of the problems that can occur with mass updates or conversions to database tables.

It would be desirable for a tool to perform mass database conversions or updates without any user interaction. Large tables would be changed quickly and multiple fields within the table would be grouped together so that each table would be processed only once. Further, it would be desirable for all indices and triggers, related to the tables, to be updated for the tables being changed, and for the data to be verified for accuracy. If a problem occurs during the conversion, it would be desirable for a tool to retry the operation before asking for user intervention, and for the tool to contain safeguards on how many tables to convert at one time and how much space is available to do the converting. The tool would have features that would allow the user to monitor the tool's conversion progress, verify its results, and recreate any triggers and/or indices that would be affected. The tool would eliminate the requirement that the user be knowledgeable in SQL programming. Further, the tool would avoid issues associated with mass updates to many database tables (e.g. transaction log filling), which the user would otherwise have to address. Accordingly, there is a need for a system for updating a database and a corresponding user interface and method therefor.

### SUMMARY OF THE INVENTION

According to one aspect of the present invention, a method and corresponding system converts data in a database from a current value to a different replacement value. The method receives information identifying a database data field to be updated and data including a current value and corresponding replacement value for replacing existing data in the identified data field. The method examines the database to determine whether the data field is associated with a trigger for initiating amendment of a database element upon alteration of the data field content, and/or an index used for locating said data field. The method disables a trigger and an index when identified by the examination. The method replaces existing data in the data field with the received replacement value. The method verifies successful replacement of the data field current value.

These and other aspects of the present invention, are further described with reference to the following detailed description and the accompanying figures, wherein the same reference numbers are assigned to the same features or elements illustrated in different figures. Note that the figures may not be drawn to scale. Further, there may be other embodiments of the present invention explicitly or implicitly described in the specification that are not specifically illustrated in the figures and visa versa.

### BRIEF DESCRIPTION OF THE DRAWINGS

FIG. 1 illustrates a block diagram of a computer in accordance with a preferred embodiment of the present invention.

FIG. 2 illustrates tables stored in the memory unit in the computer, shown in FIG. 1, in accordance with a preferred embodiment of the present invention.

FIG. 3 illustrates a method for operating the computer, shown in FIG. 1, in accordance with a preferred embodiment of the present invention.

FIG. 4 illustrates a detailed method for forming a copy table for the method shown in FIG. 3, in accordance with a preferred embodiment of the present invention.

FIG. 5 illustrates a detailed method for dropping indexes and triggers and for clearing records in the original table for the method shown in FIG. 3, in accordance with a preferred embodiment of the present invention.

FIG. 6 illustrates a detailed method for forming an updated table for the method shown in FIG. 3, in accordance with a preferred embodiment of the present invention.

FIG. 7 illustrates a detailed method for recreating indexes and triggers in the updated table for the method shown in FIG. 3, in accordance with a preferred embodiment of the present invention.

FIG. 8 illustrates a detailed method for verifying data integrity in the updated table for the method shown in FIG. 3, in accordance with a preferred embodiment of the present invention.

FIG. 9 illustrates a table of status indicators and corresponding descriptions used for the method shown in FIG. 3, in accordance with a preferred embodiment of the present invention.

FIG. 10 illustrates a user interface for the method shown in FIG. 3, in accordance with a preferred embodiment of the present invention.

FIG. 11 illustrates a user interface for the method shown in FIG. 3, in accordance with a preferred embodiment of the present invention.

FIG. 12 illustrates a user interface for the method shown in FIG. 3, in accordance with a preferred embodiment of the present invention.

FIG. 13 illustrates a user interface for the method shown in FIG. 3, in accordance with a preferred embodiment of the present invention.

FIG. 14 illustrates an example of a ControlTable for the method shown in FIG. 3, in accordance with a preferred embodiment of the present invention.

FIG. 15 illustrates a block diagram incorporating the method shown in FIG. 3, in accordance with a preferred embodiment of the present invention.

FIG. 16 illustrates set up routines for the method shown in FIG. 3, in accordance with a preferred embodiment of the present invention.

### DETAILED DESCRIPTION OF THE PREFERRED EMBODIMENTS

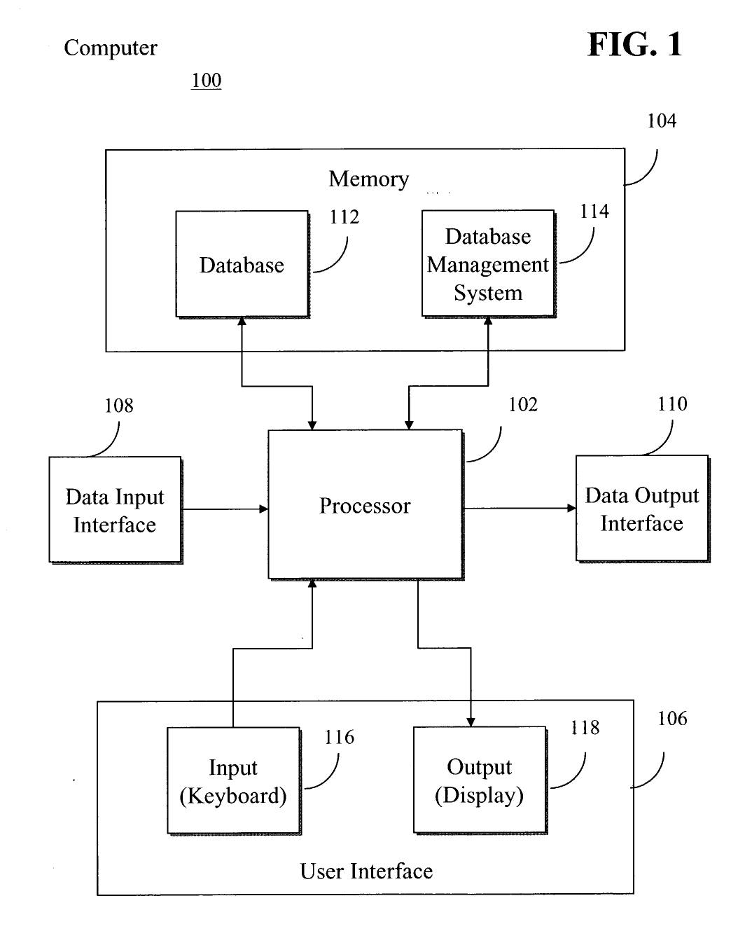

FIG. 1 illustrates a block diagram of a computer 100 in accordance with a preferred embodiment of the present invention. The computer 100 generally includes a processor 102, a memory unit 104, a user interface 106, a data input interface 108, and a data output interface 110. The memory unit 104 generally includes a database 112 and a database management system (DMS) 114. The user interface 106 generally includes an input device 116 and an output device 118.

The computer 100 may include, without limitation, a server, a workstation, a personal computer, a handheld computer, a desktop computer, a laptop computer, and the like. The computer 100 may be mobile, fixed, or convertible between mobile and fixed, depending on the particular implementation. Preferably, the computer 100 is a server adapted for a fixed implementation.

The processor 102, otherwise called a central processing unit (CPU), controls the computer 100. The processor 102 executes, retrieves, transfers, and decodes instructions over communication paths that are used to transport data to different peripherals and components of the computer 100.

The data input interface 108 and the data output interface 110 provide communication ports that permit data to be received by and sent from, respectively, the computer 100. The data input interface 108 and the data output interface 110 may be the same interface, permitting bi-directional communication, or different interfaces, permitting opposite, unidirectional communication. Examples of the data input interface 108 and the data output interface 110 include, without limitation, parallel ports and serial ports, such as a universal serial bus (USB).

The memory unit 104 includes without limitation, a hard drive, read only memory (ROM), and random access memory (RAM). The memory unit 104 is a suitable size to accommodate the database 112, the database management system 114, and all other program and storage needs, depending on the particular application.

The database 112 is a predetermined, organized collection of related information. Preferably, the database 112 is a relational database, as is well known to those skilled in the art of database design. More particularly, a relational database is a set of tables containing data fitted into predefined categories. Each table has a set of rows and columns. Each row is a set of columns with only one value for each column. All rows from the same table have the same set of columns. Each table contains one or more data categories in the columns. Each row contains a unique instance of data for the categories defined by the columns. The rows in a table are analogous to a record, and the columns are analogous to a field. Typically, a relational database has anywhere from 10 to more than 1,000 tables, and may require a memory size of several megabytes to several gigabytes or more, depending on the application.

A relational database allows a person to easily find specific information. The relational database also allows a person to sort based on any field and generate reports that contain only certain fields from each record. The relational database takes advantage of this uniformity to build completely new tables out of required information from existing tables. In other words, the relational database uses the relationship of similar data to increase the speed and versatility of the database. Hence, the data in the tables can be accessed or reassembled in many different ways without having to reorganize the tables.

Relational databases are created using a special programming language, such as structured query language (SQL), for database interoperability. SQL is the foundation for many of the popular database applications presently available today.

For example, a database of healthcare patients may have a record for each patient where each record contains fields designating specifics about the patient, such as name, home address, attending doctor, name of the healthcare enterprise, and the like. The particular values entered in the field of a table for a given patient constitute records of that table. In many applications, tables are continuously updated as records are inserted, deleted, or modified during normal operation of the database.

A database trigger is a procedure that is stored in the database and implicitly executed (i.e., “fired”) when a table is modified, as is well known to those skilled in the art of database design. The components to a database trigger include: an event that fires the trigger, a table effected by the event, an optional condition, and the code to be executed (e.g., SQL). Different types of events include, without limitation, insert, delete, and update to a table. Different types of triggers include, without limitation, a before statement (once), before every effected row, an after statement (once), and after every effected row.

A database index is a database feature used for locating data quickly within a table, as is well known to those skilled in the art of database design. A person defines a database index by selecting a set of commonly searched attribute(s) on a table and using an appropriate platform-specific mechanism to create the database index.

A database management system (DBMS) operates to retrieve data from multiple tables so that the user sees the data in single table form. The DBMS manages updates as well as other database operations, such as query processing, evaluation and optimization. Examples of conventional DBMSs include DB2, Informix, Ingres, and Microsoft SQL Server, as well as others from Oracle, Sybase, and Teradata.

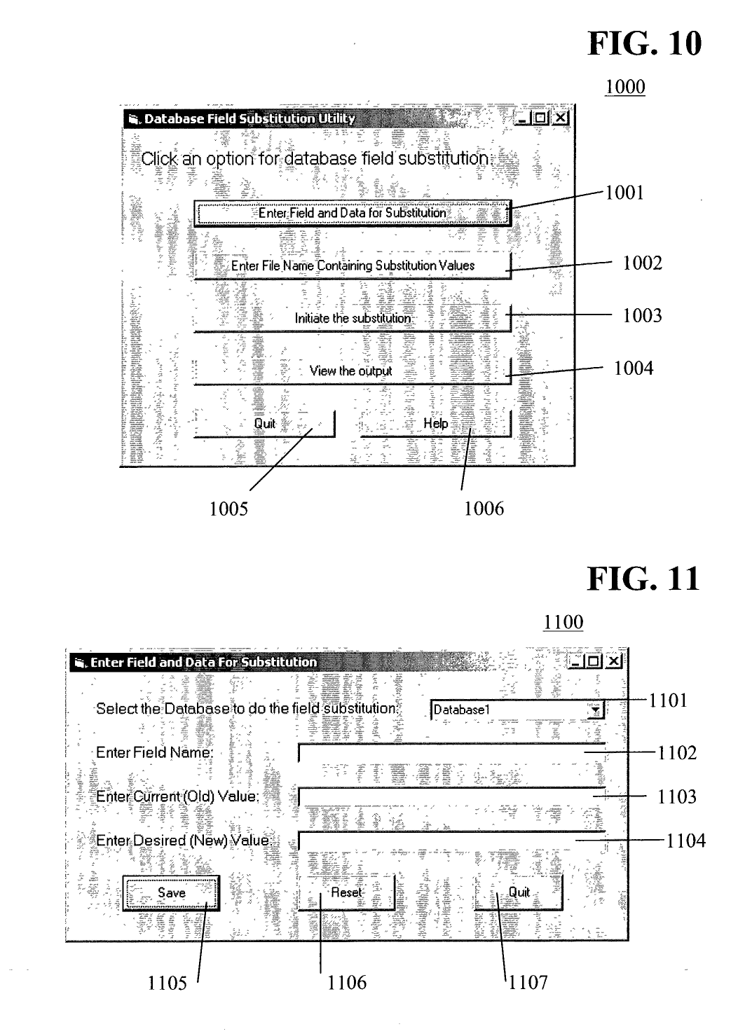

In the user interface 106, the input device 116 permits a user to input information into the computer 100 and the output device 118 permits a user to receive information from the computer 100. Preferably, the input device is a keyboard, but also may be a touch screen, a microphone with a voice recognition program, for example. Preferably, the output device is a display, but also may be a speaker, for example. The output device provides information to the user responsive to the input device receiving information from the user or responsive to other activity by the computer 100. For example, the display presents information responsive to the user entering information in the computer 100 via the keypad. FIGS. 10, 11 and 12 illustrate examples of the user interface.

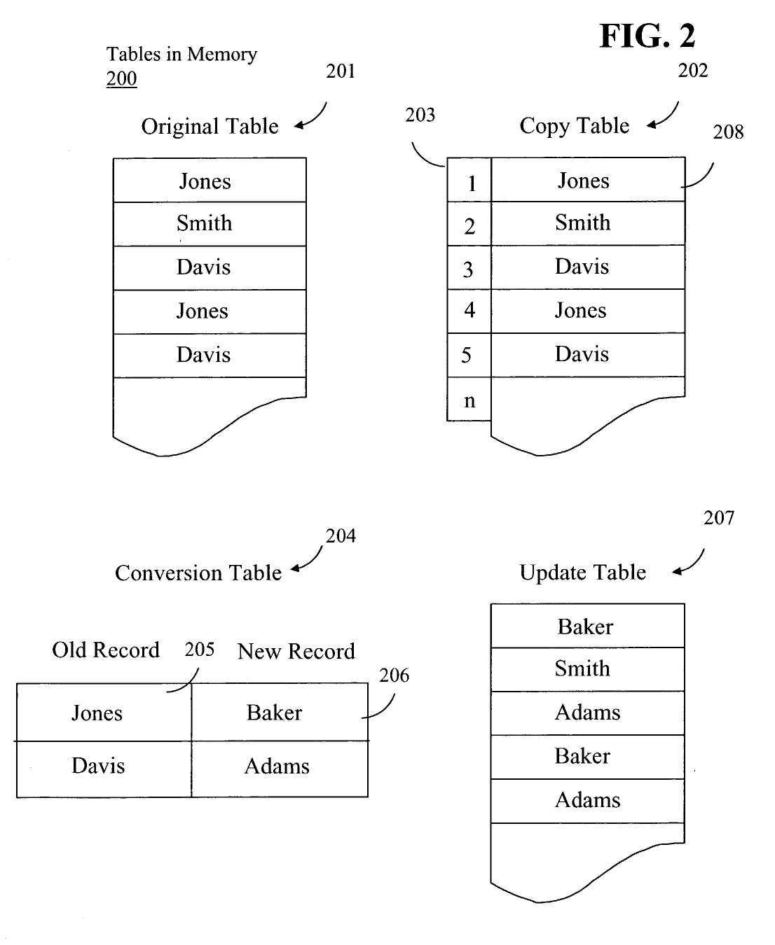

FIG. 2 illustrates tables 200 stored in the memory unit 104 in the computer 100, shown in FIG. 1, in accordance with a preferred embodiment of the present invention. The tables 200 generally include an original table 201, a copy table 202, a conversion table 204, and an update table 207. The copy table 202 further includes row numbers 203 and a current record 208 for each row. The conversion table 204 further includes an old record column 205 and a new record column 206.

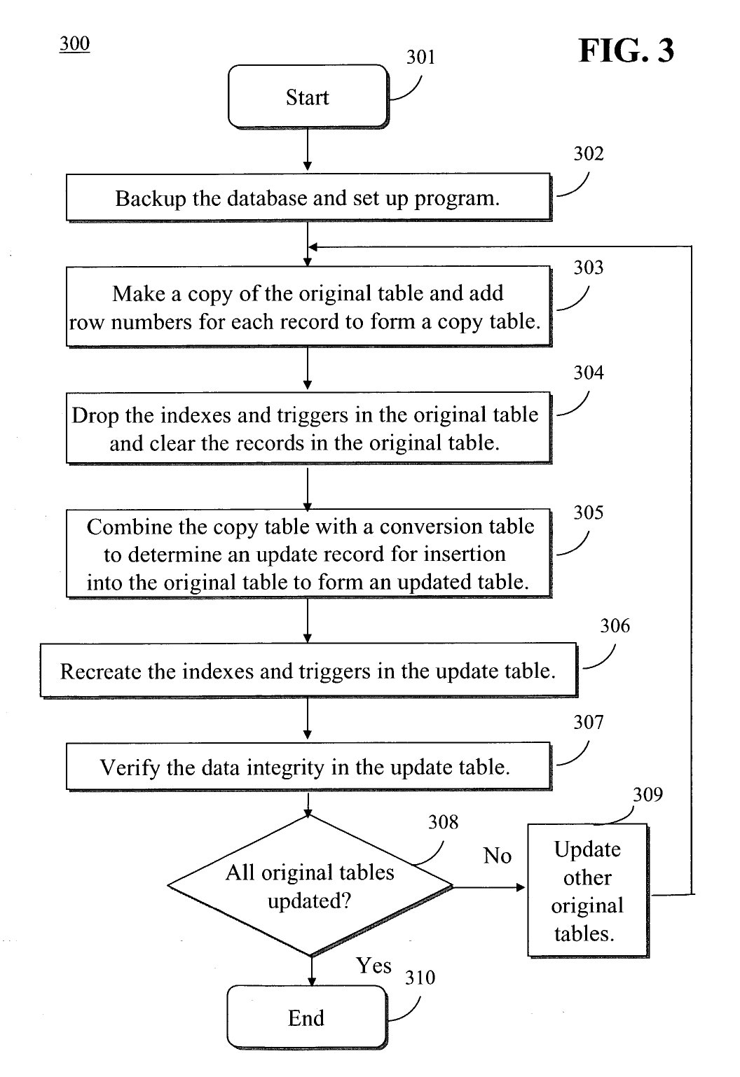

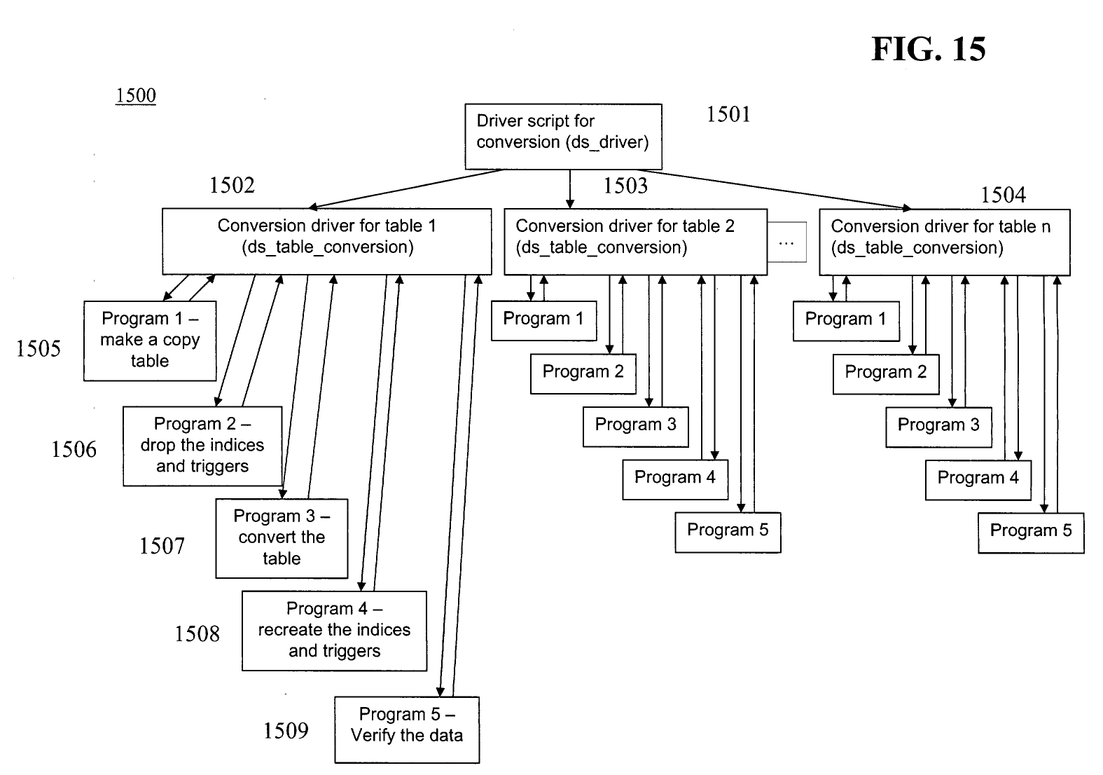

The original table 201 represents a table in the database having records that need to be updated. For example, the original table 201 includes the following current records 208: Jones, Smith, Davis, Jones, and Davis. The copy table 202 represents a copy of the original table 201 with row numbers 203 added for each record. The conversion table 204 represents old records 205 from the original table 205 that need to be replaced with corresponding new records 206. For example, the old records 205 include Jones and Davis, and the corresponding new records include Baker and Adams, respectively. The update table 207, otherwise called a production table or an updated original table, represents the original table 201 having the updated records responsive to combining the copy table 202 and the conversion table 204. For example, the update table 207 includes the following records: Baker, Smith, Adams, Baker, and Adams. Therefore, the records called Jones and Davis in the original table 201 are converted to records called Baker and Adams, respectively, in the update table 207. FIG. 3 illustrates a method 300 for operating the computer 100, shown in FIG. 1, in accordance with a preferred embodiment of the present invention. More particularly, the method in FIG. 3 describes a process for updating the original table 201 to produce the update table 207. FIG. 15 illustrates a block diagram 1500 describing the control structure for the method 300 in FIG. 3.

At step 301, the method starts.

At step 302, the computer 100 backups the database 112 to ensure that the original data is not corrupted by the data update process in steps 303-307, if a problem occurs. If a problem does not occur, then the original data may be discarded or saved for reference. If a problem does occur, then the original data may be retrieved to rerun the data update process.

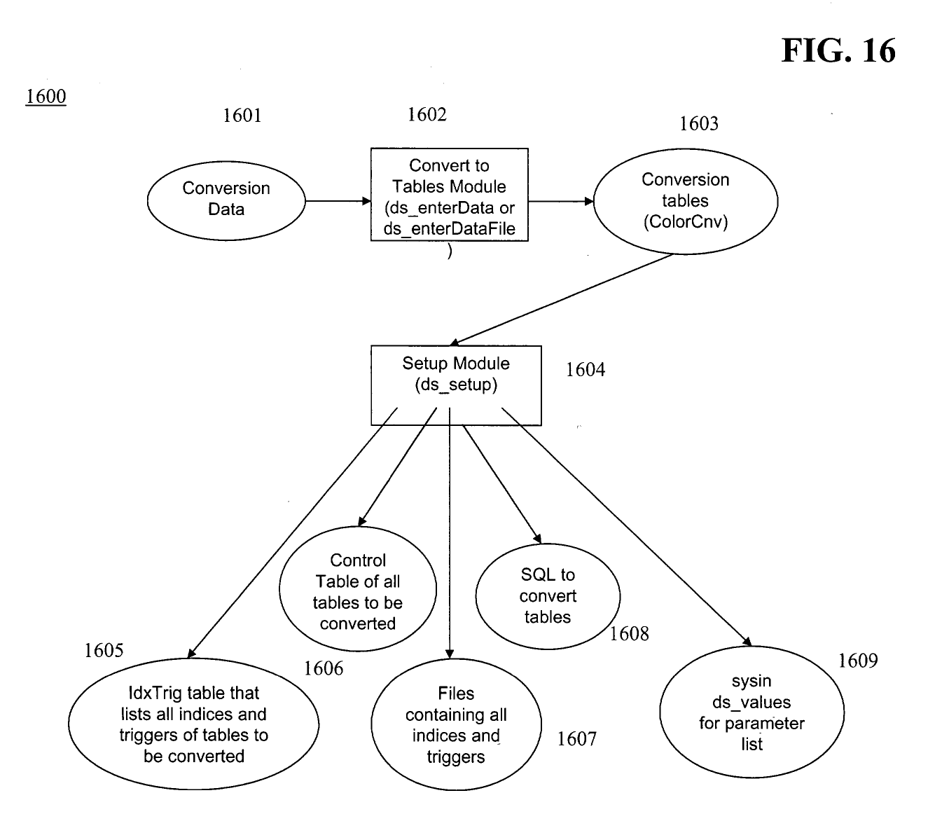

At step 302, the computer 100 also sets up the data conversion program, as described in further detail in FIG. 16. FIG. 16 includes a setup module 1604 that runs five set up routines 1605-1609 responsive to receiving the conversion tables input 1603, otherwise called a ConversionAliasTable, representing the conversion tables 204. More particularly, the computer 100 creates a ConversionAliasTable having the same definition as the fields being entered. For example, if the ClinicianID has a datatype of ClinicianID, then a search on the database for all datatypes ClinicianID are also included in the data conversion (e.g. if AssistantClinicianID, ProfessionalDoctorID, and NurseID has datatypes of ClinicianID, they would be included in the data conversion). Once all the aliases have been found, the computer 100 creates synonym conversion tables (e.g., if AssistantClinicianID, ProfessionalDoctorID, and NurseID has datatypes of ClinicianID, then all three fields would have conversion tables added with the same values in the ClinicianID conversion table).

The index/trigger (IdxTrig) table set up routine 1605 lists the indexes and triggers for each table being converted. The names of the indices and triggers and the table that they are associated with are listed in the IdxTrig database table.

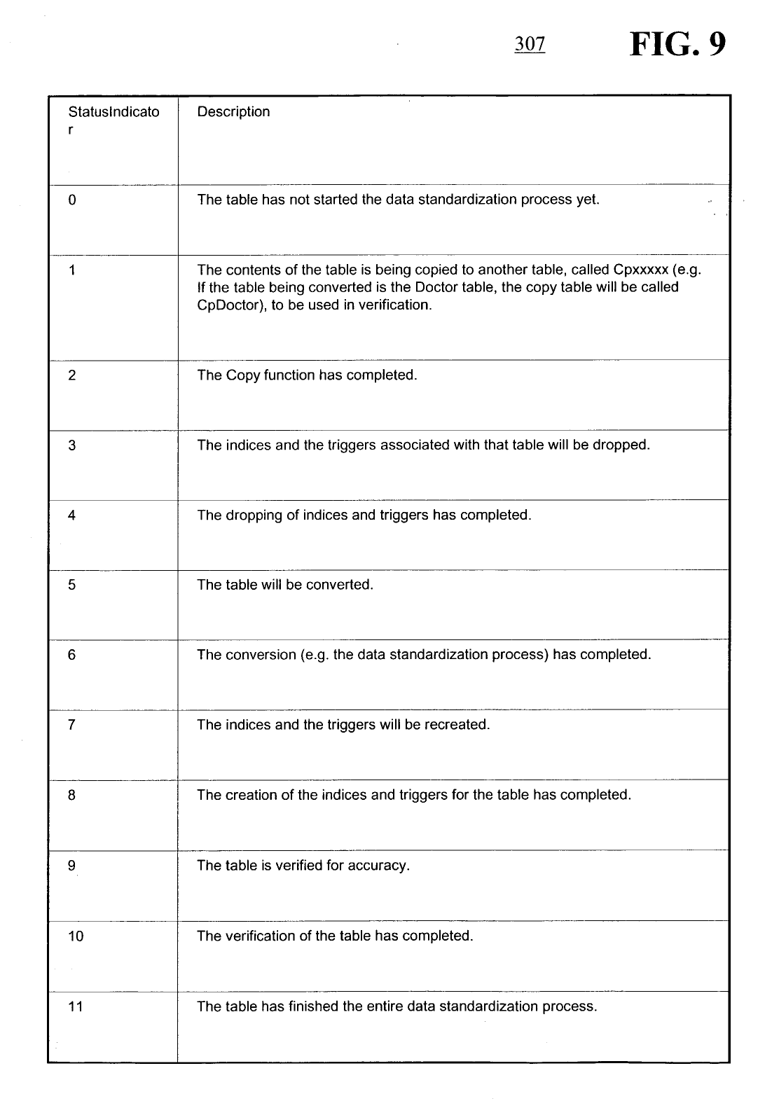

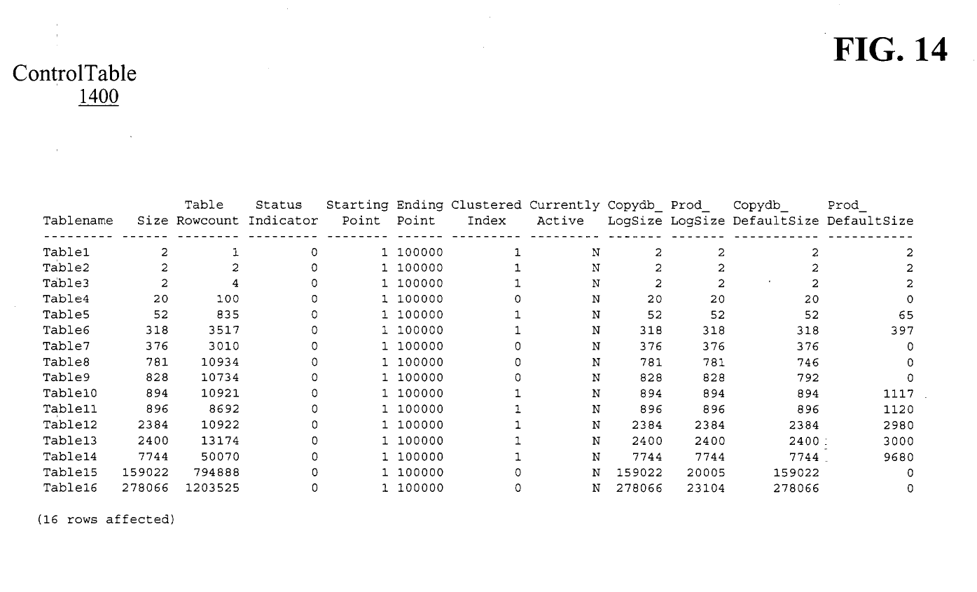

The control table set up routine 1606 contains information about each table being converted. The computer 100 creates the ControlTable 1400 that contains contain all the tables that need to be converted. This ControlTable 1400 is sorted from smallest to largest by size. FIG. 14 illustrates an example of the ControlTable 1400 before the computer 100 performs the data conversion process. The columns in FIG. 14 are described as follows. The “Tablename” column describes the names of the database tables that have at least one column that need to go through the data conversion process. The “Size” column describes the actual sizes of the corresponding tables. The computer 100 sorts the ControlTable by this column. The “TableRowcount” column describes the number of rows in each table. The “StatusIndicator” column indicates how far the data conversion process has been completed, according to corresponding descriptions, as shown in FIG. 9. For example, if the table has not been started, the field is a zero. If it is complete, it is an eleven. The “StartingPoint” column describes the beginning row number of the tables that are undergoing the conversion process. For tables that are larger than the increment set up in the user parameters, this number will be incremented. For larger tables, the increment number is used to do the conversion in smaller increments, so that if one set fails, it can be retried without doing the entire table over. For example, if a table has 300,000 rows and the increment is 100,000, the StartingPoint would be 1 and the EndingPoint would be 100,000. After these 100,000 rows have been converted, the starting indicator will be changed to 100,001 and the EndingPoint would be 200,000. Lastly, after these 100,000 rows have been converted, the StartingPoint will change to 200,001 and the EndingPoint would be 300,000. The “EndingPoint” column describes the ending row number of the tables that are undergoing the conversion process. The “ClusteredIndex” column describes a clustered index on the ControlTable. For example, if a clustered index exists on the table, it should be created before the non-clustered indices. A ‘1’ signifies that there is a clustered index on the table. A ‘0’ signifies that there is not a clustered index. The “CurrentlyActive” column describes whether the table is in the process of converting data. If the table is in the process of a data conversion, this field is a ‘Y’. If not, it is an ‘N’. The “Copydb_LogSize” column describes the size needed for the table in the logsegment. For example, if the user specified that the copy table 202 should be in a different database than where the data conversion is currently taking place, then this size is used to determine how much space is left on a logsegment of the copy database. If not enough space is left in the logsegment of the database, the next table will not start until other tables have completed and their space is freed up in the logsegment. The “Prod_LogSize” column describes the same as Copydb_LogSize, only for the production database that is going through the data conversion process. The “Copydb_DefaultSize” column describes the size needed for the table in the default segment of the copy database. The “Prod_DefaultSize” column describes the size needed for the table in the default segment of the production database. This is calculated only if a clustered index exists. Any tables that do not have any rows in them are removed from the ControlTable for efficiency purposes.

The index/trigger file set up routine 1607 creates a file for all the indexes and triggers for each table being converted. All the indexes and triggers on the database are saved to the index/trigger file in case something happens to permit these definitions to be referred to or looked up. All the indexes are saved in one file and all the triggers are saved in a separate file.

The SQL program set up routine 1608 sets up the SQL program that will execute to convert each table being converted.

The user-defined variables set up routine 1609 hold all of the user-defined variables (e.g., sysin ds_values). Any value the user wants to change can be entered after a prompt.

The following sample program output shows some of the above features being executed during the set up.

#>ds_setup

Enter the database that will be converted [def=Database1]:

Enter the database the Copy tables will reside [def=Database1]:

Do you want to keep the Copy tables after the conversion for verification (y/n)[default=n]? n

Enter the increment number to use for the conversion [def=100000]: 150000

Enter the maximum number of tables to convert at one time [default=system_defined]:

Creating ConversionAliasTable.

Creating Synonym Conversion Tables.

Creating the ControlTable.

Removing all tables from ControlTable with zero rowcounts.

Saving all the indexes and triggers on Database1.

Extracting index definitions into: cridx.sh

Extracting ‘drop index’ statements into: drop_idx.sh

Extracting trigger definitions into: crtrig.sh

Extracting ‘drop trigger’ statements into: drop_trig.sh

Creating the IdxTrig database.

Creating conversion SQL for table Table1.

ds_table_setup ended successfully

Creating conversion SQL for table Table2.

ds_table_setup ended successfully

Creating conversion SQL for table Table3.

ds_table_setup ended successfully

Creating conversion SQL for table Table4.

ds_table_setup ended successfully

Creating conversion SQL for table Table5.

ds_table_setup ended successfully

Creating conversion SQL for table Table6.

ds_table_setup ended successfully

Creating conversion SQL for table Table7.

ds_table_setup ended successfully

Creating conversion SQL for table Table8.

ds_table_setup ended successfully

Creating conversion SQL for table Table9.

ds_table_setup ended successfully

Creating conversion SQL for table Table10.

ds_table_setup ended successfully

Creating conversion SQL for table Table11.

ds_table_setup ended successfully

Creating conversion SQL for table Table12.

ds_table_setup ended successfully

Creating conversion SQL for table Table13.

ds_table_setup ended successfully

Creating conversion SQL for table Table14.

ds_table_setup ended successfully

Creating conversion SQL for table Table15.

ds_table_setup ended successfully

Creating conversion SQL for table Table16.

ds_table_setup ended successfully

ds_setup ended successfully

#>

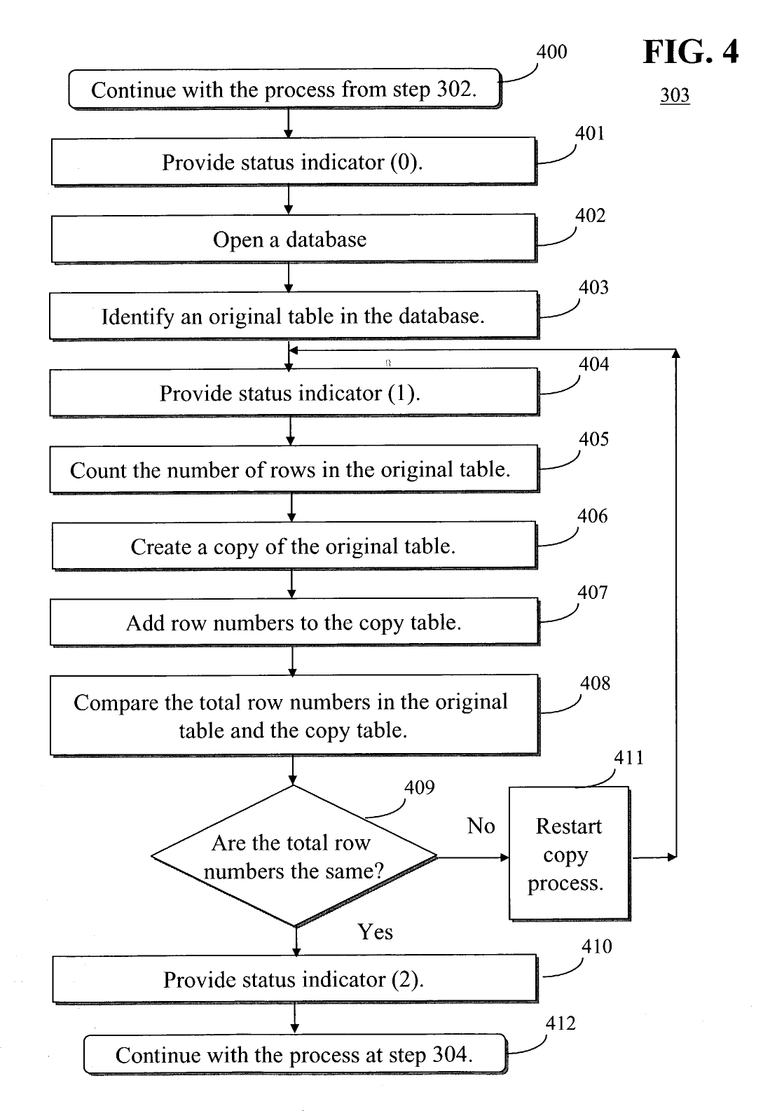

Continuing with step 303, the computer 100 makes a copy of the original table 201 and adds the row numbers 203 for each record to form a copy table 202. The copy table 202, having the row numbers 203, generally provides a table to work with during the data update process. After the update process is completed, the copy table 202 may be deleted or saved, depending on the user's preference. The row numbers 203 generally provide a way for the computer 100 to keep track of the rows during the update process. FIG. 4 provides a detailed description of step 303.

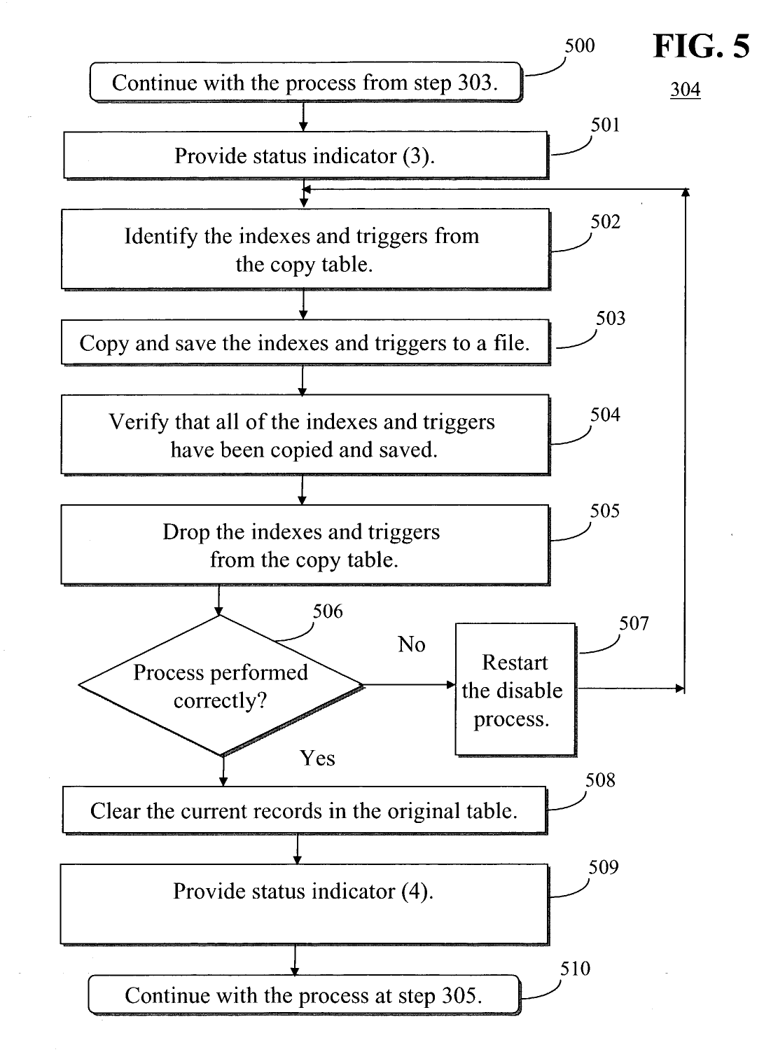

At step 304, the computer 100 drops the indexes and triggers in the original table 201 and clears the records in the original table 201. The term “drop” may otherwise be called clear, delete, store, copied, saved, and the like. The computer 100 drops the indexes and triggers before starting the data update process to prevent updated data from acting on the indexes and triggers during the data update process. Although the computer 100 drops the indexes and triggers, they are stored for reapplication to the updated table 207, after the data update process is complete. FIG. 5 provides a detailed description of step 304.

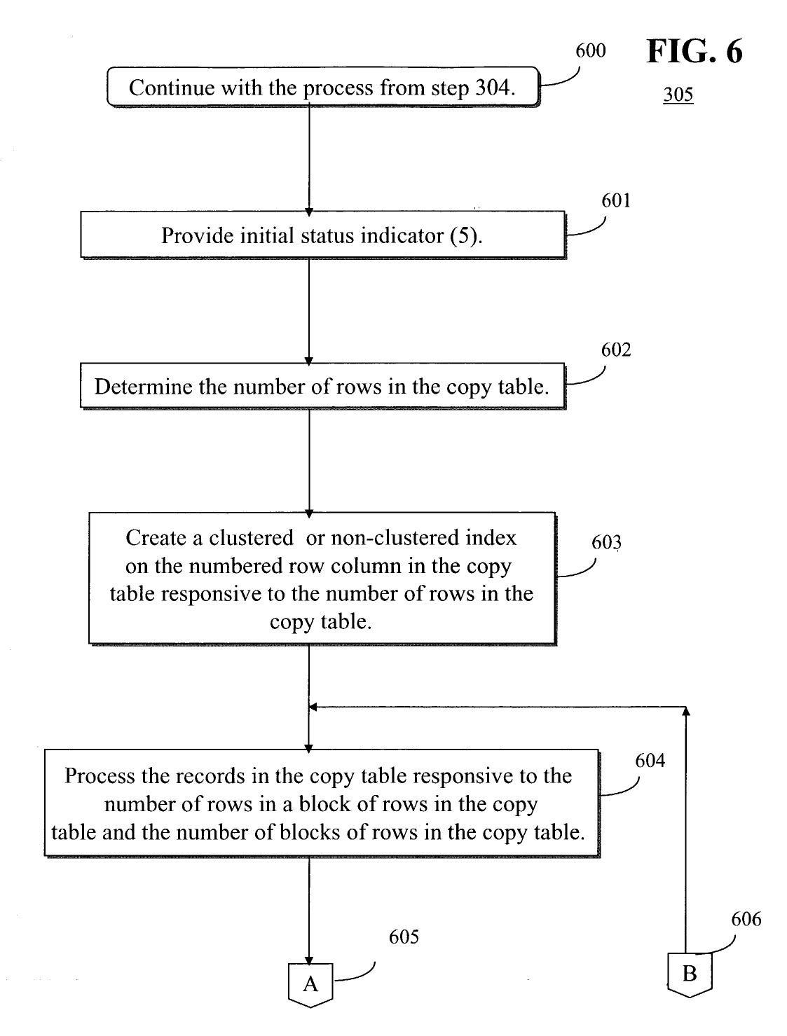

At step 305, the computer 100 combines the copy table 202 with the conversion table 204 to determine an update record for insertion into the original table 201 to form the update table 207. The term “combine” may otherwise be called join, match, compare, merge, and the like. Generally, each record in the copy table 202 is compared to one or more of the old records in the conversion table 204. If there is a match, then the new record in the conversion table 204 that corresponds to the matching old record is inserted into the update table 207 at a location that corresponds to the location of the matching record in the copy table 202. If there is not a match, then the record in the copy table 202 is inserted into the update table 207 at a location that corresponds to the location of the record in the copy table 202. FIG. 6 provides a detailed description of step 305.

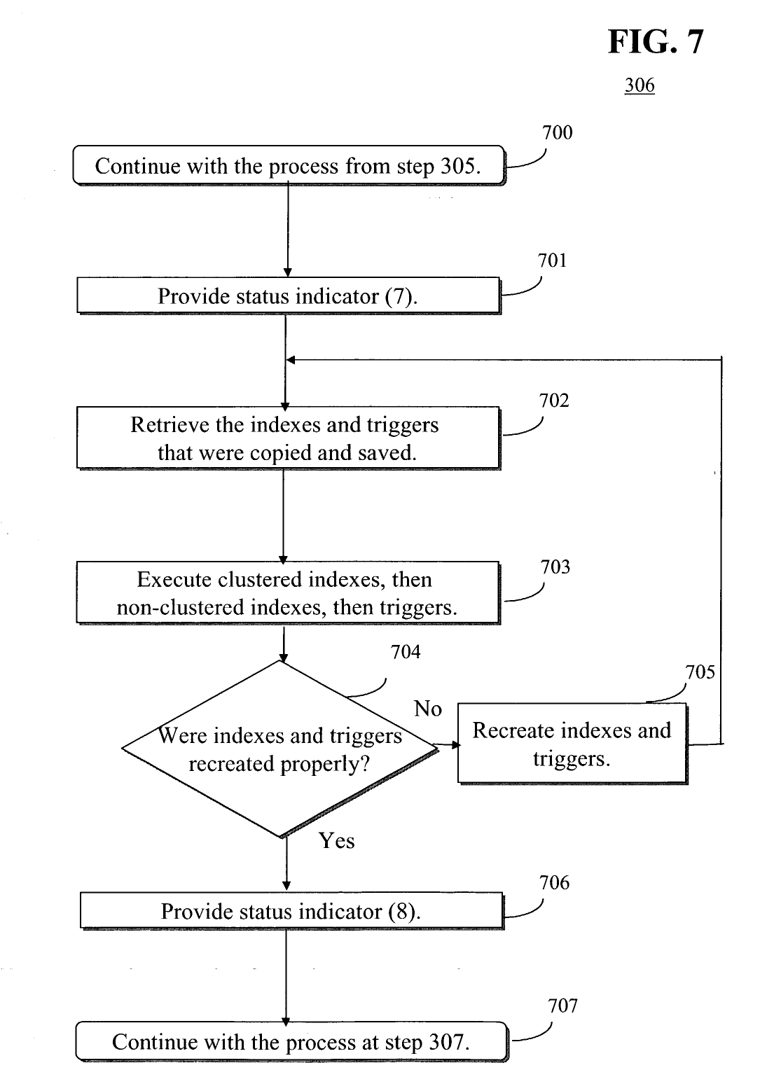

At step 306, the computer 100 recreates the indexes and triggers in the update table 207. The computer 100 recreates the indexes and triggers by retrieving them from their stored location and then by applying them to the update table 207. The computer 100 applies the indexes and triggers to the update table 207 in a manner in which they were first found in the original table 201. The updated records and non-updated in the update table 207 will have the same indexes and triggers as the corresponding records in the original table 201. Hence, the computer 100 maintains the advantages provided by the indexes and triggers in the update table 207. FIG. 7 provides a detailed description of step 306.

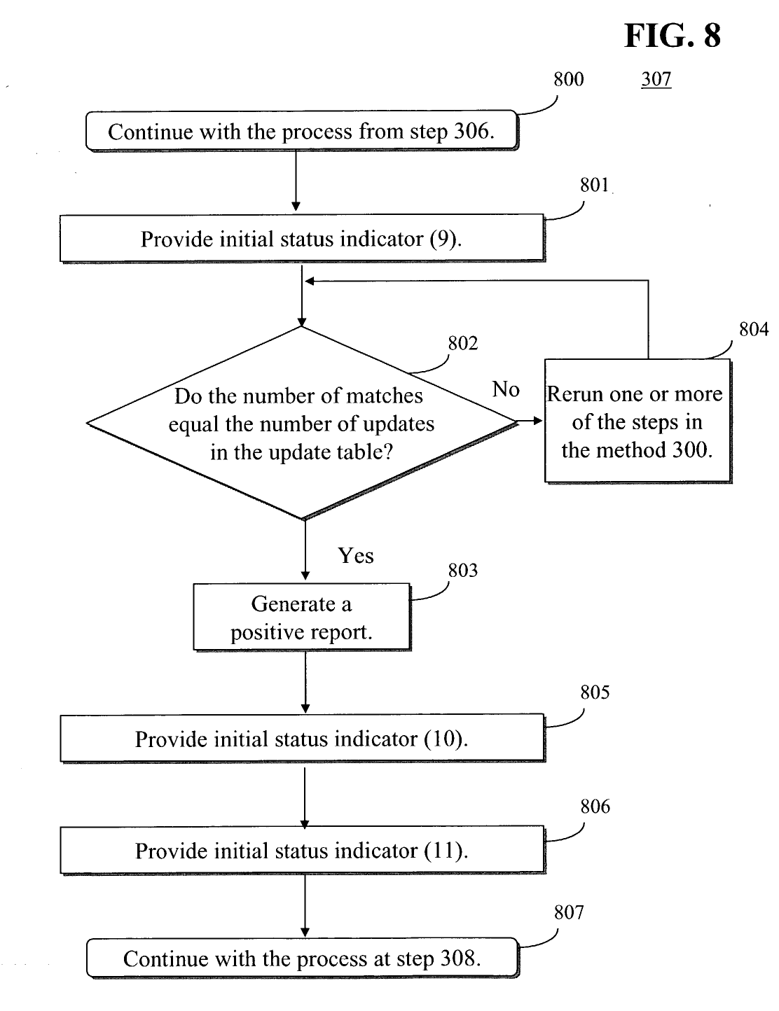

At step 307, the computer 100 verifies the data integrity in the update table 207. Generally, after the computer 100 performs steps 303 to 306, the computer 100 checks to see if the data update process was performed correctly. Preferably, the computer 100 counts a number of matches between the copy table 202 and the conversion table 204, and compares the number of matches to a number of updated records in the update table 207. If the number of matches is equal to the number of updates, then the computer 100 determines that the data integrity is high. However, if the number of matches is not equal to the number of updates, then the computer 100 determines that the data integrity is low indicating that a problem may have occurred during the data update process. FIG. 8 provides a detailed description of step 307.

At step 308, the computer 100 determines whether other original tables in the database 112 need to be updated. If the computer 100 determines that other original tables in the database 112 need to be updated, then the computer 100 continues to step 309; otherwise, the computer 100 continues to step 310.

At step 309, the computer identifies a next original table 201 from the control table 1400 that needs to be updated and then continues to step 303 to begin the update process on the next original table 201.

At step 310, the method ends.

FIG. 4 illustrates a detailed method 303 for forming the copy table 202 for the method shown in FIG. 3, in accordance with a preferred embodiment of the present invention. Generally, the method 303 makes a copy of the original table 201 and adds row numbers 203 to form the copy table 202.

At step 400, the method continues from step 302 in FIG. 3.

At step 401, the computer 100 provides a status indicator (0), as shown in FIG. 9, indicating that the method has not started the data standardization process yet. The term “standardization” may otherwise be called update, conversion, and the like. Preferably, the ControlTable 1400 (FIG. 14) sets the status indicator (0) (FIG. 9) during the set up process. The status indicator (0), as well as the other status indicators (1-11), advantageously provides a user with feedback about what part of the process the computer 100 is operating in. The status indicators may be presented to the user in various ways using the data output device 118 of the user interface 106 including, without limitation, visual or audible feedback.

At step 402, the computer 100 opens the database 112, using a process well known to those skilled in the art of database operation.

At step 403, the computer 100 identifies the original table 201 in the database 112, using a process well known to those skilled in the art of database operation. As mentioned with reference to FIG. 3, the database 112 may have more than one original table 201 that are identified an updated one at a time.

At step 404, the computer 100 provides a status indicator (1), as shown in FIG. 9, indicating that the method 303 is making a copy of the original table 201 to form the copy table 202.

At step 405, the computer 100 counts the number of rows in the original table 201 corresponding to the number of records in the original table 201. Preferably, the computer 100 writes out the number of records in the original table 201 to a file so that the user knows how many records were in the original table 201 before the data update process begins.

At step 406, the computer 100 creates a copy of the original table 201. Practically, the copy table 202 has the phrase “Cp” added to the beginning of the name of the original table 201 (“tablename”) to designate it as the copy table 202 (“Cp(tablename)”). All of the records in the original table 201 (“tablename”) are copied to the copy table 202 (“Cp(tablename)”).

At step 407, the computer 100 adds row numbers 203 to the copy table 202. The row numbers 203 are added for use in step 303 and in step 305 when the copy table 202 is combined with the conversion table 204. Preferably, the combining process in step 305 is performed on a predetermined number of rows, otherwise called a block of rows, at a time to permit the computer 100 to maintain control over the combining process in step 305. Practically, the additional rows are called row_id and are added to the copy table 202 as an additional column.

At step 408, the computer 100 compares the total row numbers in the original table 201, as determined in step 404, to the total row numbers in the copy table 202, as provided in step 407.

At step 409, the computer 100 determines whether the total row numbers (“rowcount”) in the original table 201 and the total row numbers (“Cprowcount”) in the copy table 202 are the same. If the computer determines that the total row numbers in the original table 201 and the total row numbers in the copy table 202 are the same, then the method continues to step 410; otherwise, the method continues to step 411. Since the number of rows corresponds to the number of records in each of the original table 201 and the copy table 202, steps 408 and 409 provides a general way for determining whether all of the records in the original table 201 were copied correctly into the copy table 202. Preferably, the computer 100 generates error return codes or messages representing results of the determination made in step 409.

At step 410, the computer 100 provides a status indicator (2), as shown in FIG. 9, indicating that the formation of the copy table is complete and successful.

At step 411, the computer 100 restarts step 303 by returning to step 404 in another attempt to make the copy table 202. Alternatively, the method 303 may return to step 401 so that the status indicator is reset to (0). Still alternatively, the method 303 may return to any step in step 303 to rerun only those steps necessary to properly complete the process.

At step 412, the method continues to step 304 in FIG. 3.

FIG. 5 illustrates a detailed method 304 for dropping indexes and triggers and for clearing records in the original table 201 for the method 300 shown in FIG. 3, in accordance with a preferred embodiment of the present invention.

At step 500, the method continues from step 303 in FIG. 3.

At step 501, the computer 100 provides a status indicator (3), as shown in FIG. 9, indicating that the indexes and triggers for the original table 202 will be dropped.

At step 502, the computer 100 identifies the indexes and triggers from the original table 202, in a manner that is well known to those skilled in the art of database operation.

At step 503, the computer 100 copies and saves the indexes and triggers to a file, in a manner that is well known to those skilled in the art of database operation. Preferably, each index and trigger is saved to its own file, for example in a ../ds/tablename directory using SQL to get the original table's trigger and index definitions. Hence, although the indexes and triggers are dropped from the original table 201, they are saved for later application to the update table 207, as described with reference to FIG. 7.

At step 504, the computer 100 verifies that all of the indexes and triggers have been copied and saved, in a manner that is well known to those skilled in the art of database operation. Preferably, the computer 100 accesses an IdxTrig table to verify that all of the indexes and triggers for the original table 201 have been copied.

At step 505, the computer 100 drops the indexes and triggers from the original table 201.

At step 506, the computer 100 determines whether steps 502, 503, 504, and 505 have been performed correctly. If the computer determines that steps 502, 503, 504, and 505 have been performed correctly, then the method continues to step 508; otherwise the method continues to step 507. Preferably, the computer 100 determines whether steps 502, 503, 504, and 505 have been performed correctly by checking that the error return codes from the drop operation are zero.

At step 507, the computer 100 restarts the process to drop the indexes and triggers in the copy table 202. From step 507, the method continues to step 502, wherein the method 304 is performed again on a clean version of the original table 201 that has the indexes and triggers. Alternatively, the method 303 may return to any step in step 304 to rerun only those steps necessary to properly complete the process.

At step 508, the computer 100 clears the current records in the original table 201. Preferably, the computer 100 removes the current records while retaining the definition of the original table 201, including the fields. Hence, the original table 201 is clear of all records, indexes and triggers, and is ready to be rebuilt using the copy table 202 and the conversion table 204 to form the update table 207, according to steps 305, 306, and 307.

At step 509, the computer 100 provides a status indicator (4), as shown in FIG. 9, indicating that indexes and triggers for the original table 201 have been dropped and that the current records have been cleared successfully.

At step 510, the method continues to step 305 in FIG. 3.

FIG. 6 illustrates a detailed method 305 for forming an update table 207 for the method 300 shown in FIG. 3, in accordance with a preferred embodiment of the present invention. Generally, the computer 100 forms the update table 207 by combining the copy table 202 with the conversion table 204.

At step 600, the method continues from step 304 in FIG. 3.

At step 601, the computer 100 provides a status indicator (5), as shown in FIG. 9, indicating that the method is forming the updated table 207.

At step 602, the computer 100 determines the number of rows 203 in the copy table 202. Preferably, the computer 100 performs the data conversion process in increments of a predetermined number of rows 203, otherwise called a block of rows. Preferably, the predetermined number of rows 203 are consecutive rows. More particularly, the increments are a parameter entered from a file sysin ds_values.

At step 603, the computer 100 creates a clustered or a non-clustered index on the numbered row column in the copy table 202 responsive to the number of rows in the copy table 202. A clustered index defines the order of the physical records on a table. A non-clustered index is a fast way to extract data from a column using a column or multiple columns as a key. Preferably, if the rowcount of the copy table 202, as listed in a ControlTable, is greater than 10 million rows, then a non-clustered index is created on the row_id column 203 of the copy table 202 to speed up the conversion process. If the rowcount of the copy table 202, as listed in a ControlTable, is greater than 200,000, but less than 10 million rows, then a clustered index is created on the row_id column 203 to speed up the data conversion process even more. If the rowcount of the copy table 202, as listed in a ControlTable, is less than 200,000 rows, then no index needs to be created to speed up the conversion.

At step 604, the computer 100 processes the records in the copy table 202 responsive to the number of rows in a block of rows in the copy table 202 and the number of blocks of rows in the copy table 202. Preferably, the computer 100 processes the records in the copy table 202 on a row-by-row basis, otherwise referred to as one row at a time.

At step 605, the method 305 is a continuation from step 604 to step 607.

At step 606, the method 305 is a continuation from steps 611, 613, or 615 to step 604.

At step 607, the computer 100 determines whether the current record 208 in the copy table 202 is the same as the old record 205 in the conversion table 204. If the computer 100 determines that the current record 208 in the copy table 202 is the same as the old record 205 in the conversion table 204, then the method continues to step 608; otherwise, the method continues to step 609. Hence, at step 607, the computer 100 determines which records need to be changed and which records do not need to be changed on a row-by-row basis.

At step 608, the computer 100 inserts the new record 206 from the conversion table 204 into the field in the update table 207. Preferably, the computer 100 performs the insert operation using an SQL command. Hence, the new record 206 in the update table 207 corresponds to the current record 208 in the copy table 202 for that particular row.

At step 609, the computer 100 inserts the current record 208 from the copy table 202 into the field in the update table 207. Preferably, the computer 100 performs the insert action using an SQL command. Hence, the current record 208 in the update table 207 corresponds to the current record 208 in the copy table 202 for that particular row. Step 609 effective provides that no change is made to the current records that do not need to be updated. Alternatively, the update table 207 may initially have a copy of all of the current records in the copy table 202. Then, in step 608, the computer would perform a delete action on the particular field for current record in the particular row before performing the insert action with the new record 206. This alternative step 608 effectively provides a replace action to the current record with the new record 206. By using the alternative step 608, the present step 609 would not be used, since the update table 207 would already have the current records from the copy table 202. Various other methods to provide the proper records in the update table 207 may be used with corresponding advantages and disadvantages.

At step 610, the computer 100 determines whether the last row in the current block of rows has been reached. If the computer 100 determines that the last row in the current block of rows has been reached, then the method continues to step 612; otherwise, the method continues to step 611.

At step 611, the computer 100 advances to the next row in the block of rows and continues to step 604 to process more records.

At step 612, the computer 100 determines whether the current block of rows updated properly. If the computer determines that the current block of rows updated properly, then the method continues to step 614; otherwise, the method continues to step 613. Preferably, the computer 100 determines whether the current block of rows updated properly by checking error return codes and rowcount values. If the rowcount value does not equal the increment amount, then an error occurred and the method continues to step 613. If the rowcount value equals the increment amount and the error return code is zero, then the method continues to step 614.

At step 613, the computer 100 reruns the update for the block of rows and continues to step 604 to process the same block of rows, or a subset thereof.

At step 614, the computer 100 determines whether the block of rows is the last block of rows in the table. If the computer 100 determines that the block of rows is the last block of rows in the table, then the method continues to step 616; otherwise, the method continues to step 615.

At step 615, the computer 100 advances to the next block of rows and continues to step 604 to process more records.

At step 616, the computer 100 provides a status indicator (6), as shown in FIG. 9, indicating that the formation of the update table 207 is complete. Hence, the update table 207 contains all of the records from the original table 201 that were not updated and all of the records that were updated responsive to combining the copy table 202 with the conversion table 204.

At step 617, the method continues to step 306 in FIG. 3.

FIG. 7 illustrates a detailed method 306 for recreating indexes and triggers in the update table 207 for the method 300 shown in FIG. 3, in accordance with a preferred embodiment of the present invention.

At step 700, the method continues from step 305 in FIG. 3.

At step 701, the computer 100 provides a status indicator (7), as shown in FIG. 9, indicating that the indexes and triggers for the update table 207 are being recreated.

At step 702, the computer 100 retrieves the indexes and triggers that were copied and saved.

At step 703, the computer 100 executes clustered indexes, then non-clustered indexes, then triggers. In step 703, the term “execute” may otherwise mean apply, recreate, and the like. Preferably, the computer 100 accesses an IdxTrig table for the indexes and triggers and executes the clustered indexes first, followed by the nonclustered indexes, followed by the triggers. The computer 100 executes in this order because of performance considerations and the way that the data is stored on the database. Since clustered indexes move records around in the table and the non-clustered indexes do not, clustered indexes are created first. If a record that went through the data conversion is no longer a unique key when a clustered index is being created, then that record is written out to a table, for example Dt(tablename), so that the user can determine if this record should be added after the data conversion process.

At step 704, the computer 100 determines whether the indexes and triggers were properly recreated. If the computer 100 determines that the indexes and triggers were properly recreated, then the method continues to step 705; otherwise, the method continues to step 706. Preferably, the computer 100 performs step 704 by checking the return codes from creating the indexes and the triggers.

At step 705, the computer reruns the method to recreate the indexes and triggers. Preferably, the computer 100 determines which indexes and triggers have already been recreated properly and continues with at the next index or trigger that was recreated improperly.

At step 706, the computer 100 provides a status indicator (8), as shown in FIG. 9, indicating that the indexes and triggers for the update table 207 were recreated.

At step 707, the method continues to step 307 in FIG. 3.

FIG. 8 illustrates a detailed method 307 for verifying data integrity in the update table 207 for the method 300 shown in FIG. 3, in accordance with a preferred embodiment of the present invention.

At step 800, the method continues from step 306 in FIG. 3.

At step 801, the computer 100 provides a status indicator (9), as shown in FIG. 9, indicating that the method 307 is verifying the data integrity in the update table 207.

At step 802, the computer 100 compare the number of positive matches, as determined in step 607 in FIG. 6, to the number of updated records in the update table 207. For example, if the color red was changed to the color blue fifty times during the combining process, the number fifty is compared with the number of times the color blue exists in the update table 207. If the computer 100 determines that the number of positive matches is the same as the number of updated records, then the method continues to step 803; otherwise, the method continues to step 804. Preferably, the Dt(tablename), created in step 306, is taken into account as duplicate records would change the results in step 802. Hence, at step 802, the computer 100 compares counts to verify that the computer 100 performed the method 300 properly.

At step 803, the computer 100 generates a report that shows the old value, new value, and the number of times the new value appears in the updated table 207 and/or the entire database 112.

At step 804, the computer 100 reruns the verification process by returning to step 802. If necessary, the computer 100 returns back to one or more of the previous steps, described above, to rerun one or more aspects of the method 300 until the verification is correct. Optionally, a report of the area of the database 112 having the discrepancy may also be generated.

At step 805, the computer 100 provides a status indicator (10), as shown in FIG. 9, indicating that the method 307 has verified the data integrity in the update table 207.

At step 806, the computer 100 provides a status indicator (11), as shown in FIG. 9, indicating that the method 300 has completed the entire data conversion process.

At step 807, the method continues to step 308 in FIG. 3.

FIG. 9 illustrates a table of status indicators (e.g., StatusIndicator) and corresponding descriptions used for the method shown in FIG. 3, in accordance with a preferred embodiment of the present invention. The StatusIndicator on the ControlTable 1400 is used to determine which step in the data conversion process the table is currently on. Preferably, the StatusIndicator is a number from zero to eleven and having corresponding descriptions as shown in FIG. 9.

Next, FIGS. 10, 11, 12, and 13 illustrate examples of a graphical user interface to operate the data conversion method shown in FIG. 3. The graphical user interface in each of FIGS. 10, 11, 12, and 13 permits a user to view output data from the interface using the data output device 118, preferably implemented as a display, and to input data into the interface using the data input device 116, preferably implemented as a keyboard and a mouse. FIG. 10 is the main or top-level graphical user interface. The computer 100 presents the graphical user interface in FIGS. 11, 12, and 13 when the user selects a particular corresponding selection boxes in FIG. 10. Although the computer 100 presents graphical user interface in each of FIGS. 10, 11, 12, and 13 in the form of a window having selection boxes, drop down menu items, and input data fields, any other type user interface may be used to provide the same functions.

FIG. 10 illustrates a user interface window 1000 for the method shown in FIG. 3, in accordance with a preferred embodiment of the present invention. The window 1000 includes selection boxes labeled “Enter Field and Data for Substitution” 1001, “Enter File Name Containing Substitution Values” 1002, “Initiate the substitution” 1003, “View the output” 1004, “Quit” 1005, and “Help” 1006.

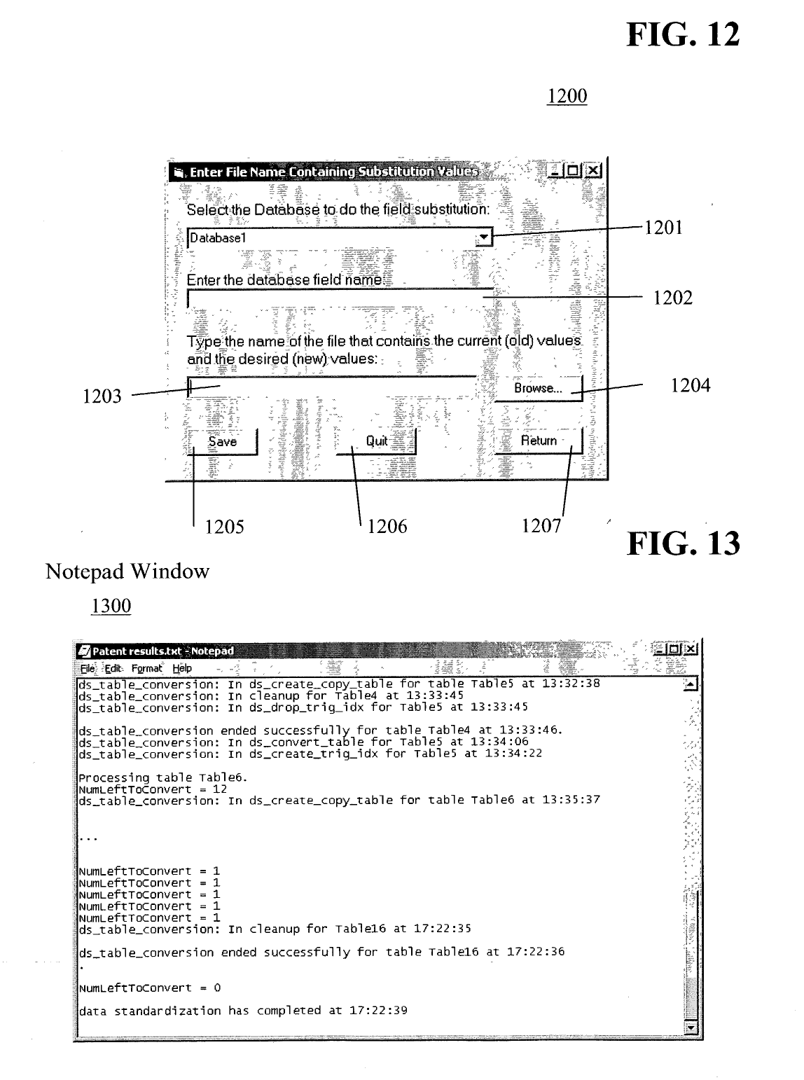

When the user selects the box labeled “Enter Field and Data for Substitution” 1001, the computer 100 opens the user interface window 1100 shown in FIG. 11. When the user selects the box labeled “Enter File Name Containing Substitution Values” 1002, the computer 100 opens the user interface window 1200 shown in FIG. 12. When the user selects the box labeled “Initiate the substitution” 1003, the computer 100 begins the data conversion process. When the user selects the box labeled “View the output” 1004, the computer 100 opens the user interface window 1300 shown in FIG. 13. When the user selects the box labeled “Quit” 1005, the computer 100 quits the data conversion process. When the user selects the box labeled “Help” 1006, the computer 100 provides help notes (not show) about the data conversion process.

More particularly, to start the data conversion process 300, the user first needs to set up the conversion tables 204 in the database to tell the data conversion tool what the name of the field is, what the old value 205 of the field is, and what the new value 206 should be. Preferably, this setup can be done using either a program, having a user interface as shown in FIG. 11, or a file, having a user interface as shown in FIG. 12.

FIG. 11 illustrates a user interface window 1100 for the method shown in FIG. 3, in accordance with a preferred embodiment of the present invention. The window 1100 includes a drop down menu 1101 for selecting a database, an input window 1102 for receiving a field name, an input window 1103 for receiving a current (old) value, an input window 1104 for receiving a desired (new) value, a save box 1105, a reset box 1106, and a quit box 1107.

The drop down menu 1101 permits a user to select the database that will undergo the data conversion process. The input window 1102 permits the user to enter the field name that will undergo the data conversion process. The input window 1103 permits the user to enter the current (old) value 205 for the conversion table 204. The input window 1104 permits the user to enter the desired (new) value 206 for the conversion table 204. When the user selects the save box 1105, the computer 100 saves the entered data in the conversion table 204 and clears the input windows 1102, 1103, and 1104. When the user selects the reset box 1106, the computer 100 resets, or otherwise clears, the entered data. When the user selects the quit box 1107, the computer 100 quits the data conversion process. Hence, the window 1100 permits the user to manually enter the field name and corresponding current value and desired value.

More particularly, when the program (e.g., ds_enterData) is used, the program prompts the user for the database 112 to be converted and the database where these conversion tables will reside. The program then prompts the user to enter the field (e.g., Color) to be converted. The ds_enterData program checks if a conversion table 204 by the name of ColorCnv currently exists in the database 112. If it does, then the program prompts the user to either delete the conversion table 204 or append values at the end of the existing table. Once that decision has been made, the name of the field will be displayed with the data type (character, integer, etc.) and the length. Then the user will be prompted for the old value 205 and the new value 206 until all the values have been entered. Once all the data has been entered, the user presses save and the program clears the fields to permit the user to enter a another field and additional old and new values. If the user presses the quit box, the program ds_enterData ends. Upon pressing the quit box, the program creates the table ColorCnv.

FIG. 12 illustrates a user interface window 1200 for the method shown in FIG. 3, in accordance with a preferred embodiment of the present invention. Generally, FIG. 12 offers an alternative method to that shown in FIG. 11 for entering information needed for the data conversion process. The window 1200 includes a drop down menu 1201 for selecting a database, an input window 1202 for receiving a database field name, in input window 1203 for receiving a name of a file that contains the current (old) values and the desired (new) values, a browse box 1204, a save box 1205, a quit box 1206, and a return box 1207.

The drop down menu 1201 permits a user to select the database that will undergo the data conversion process. The input window 1202 permits the user to enter the field name that will undergo the data conversion process. The input window 1203 permits the user to enter the name of the file that contains the current (old) values and the desired (new) values for the conversion table 204. When the user selects the browse box 1204, the computer 100 permits the user to browse and select files on the computer 100, such by opening an Explorer® window, in a manner well known to those skilled in the art of computer user interfaces. When the user selects the save box 1205, the computer 100 saves the entered data in the conversion table 204 and clears the input windows 1202 and 1203. When the user selects the quit box 1206, the computer 100 quits the data conversion process. When the user selects the return box 1207, the computer 100 closes the window 1200 and returns to the window 1000 in FIG. 10. Hence, the window 1100 permits the user to manually enter the field name, and automatically enter, via the file, the corresponding current value and the corresponding desired value. Alternatively, the window 1100 may also permit the user to automatically enter the field name, if desired.

More particularly, the user could load the old and new values in an Excel® spreadsheet, WordPad®, or any other data entry method. Regardless of how the data is stored, the data can be converted to a text, tab delimited file (e.g., *.txt) to the place where the database resides and having a name of the field name plus a suffix (e.g., Cnv.txt). Using an earlier example, the name of the file could be ColorCnv.txt. The computer 100 calls a program (e.g., ds_enterDataFile) with the all the file names entered as parameters (e.g. ds_enterDataFile ColorCnv.txt FlavorCnv.txt CarCnv.txt). The ds_enterDataFile program prompts the user for the name of the database that will be converted and the name of the database the conversion tables should reside. Then, the program converts each of the text files to database tables called ColorCnv, FlavorCnv, and CarCnv. After each table has been created, a message can be displayed to the user telling them if it was successful or not. If it is not created successfully, a log file or error screen can be made for the user to look in/at for more information.

FIG. 13 illustrates a user interface window 1300 for the method shown in FIG. 3, in accordance with a preferred embodiment of the present invention. The window 1300, provided in a notepad format, provides an example of a log of the results of the data conversion process.

FIG. 14 illustrates an example of a ControlTable 1400 for the method shown in FIG. 3, in accordance with a preferred embodiment of the present invention. The computer 100 creates the ControlTable 1400 during an initial set up process. The ControlTable 1400 contains information related to all of the tables in a database that needs to be converted. FIG. 3, step 302 provides a detailed description of the ControlTable 1400.

FIG. 15 illustrates a block diagram 1500 incorporating the method shown in FIG. 3, in accordance with a preferred embodiment of the present invention. The ds_driver program 1501 controls the entire data conversion process by starting a conversion program for each table (ds_table_conversion) 1502, 1503, and 1504, for example. The table conversion programs 1502, 1503, and 1504 each run a series of five programs 1505, 1506, 1507, 1508, and 1509, corresponding to the steps 303, 304, 305, 306, and 307 in FIG. 3 to perform the data conversion for each table. When each of the programs 1505, 1506, 1507, 1508, and 1509 for a table are finished, control is sent back to the table conversion program 1502, 1503, and 1504. When a table has been converted, the ds_table_conversion program 1502, 1503, and 1504 sends control back to the ds_driver program 1501 signifying the table has completed the data conversion process. Then, the ds_driver program 1501 starts another ds_table_conversion program 1502, 1503, and 1504 until all “n” tables have completed the data conversion process. The interaction of the blocks in the block diagram 1500 permits the computer 100 to maintain orderly control over the data conversion process.

More particularly, after the user completes the set up, the user can start the data conversion process for the selected databases by executing the driver program 1501 (e.g., ds_driver). The driver program 1501 runs during the entire data conversion process and will stop when the last table is completed. The driver program reads in the parameters set by the user in the file called sysin ds_values. An infinite loop runs starting a new conversion process on a new table once every minute until the maximum number of tables to convert at one time set up by the user has been satisfied. The smallest table found in the ControlTable 1400 will go through the data conversion process first, followed by the next to smallest, etc. When a table is selected to go through the data conversion process, a flag on the ControlTable 1400 for the table called CurrentlyActive is set a ‘Y’. The next conversion program (e.g., ds_table_conversion) is called and executes the data conversion process for the table. Log files are created for each program in the process and stored in the directory ../ds/tablename so that the user can look at output for that table to see where in the conversion the process is at and what tables are currently being changed.

The ds_table_conversion program 1502-1504 is run for each table that needs to have a field(s) changed from one value to another. The conversion program can run up to five more programs that do the main work of the data conversion process. The author or user of the conversion program may determine whether indexes and triggers should be deleted and recreated or not. If not, there will be only three programs. Preferably, the indexes and triggers are deleted and recreated causing five programs to be used.

After each SQL program is run, an error return code is checked to make sure it is equal to zero. Sometimes the error return code is checked and the rowcount is checked to make sure if it matches the expected results. If it does not, the program restarts.

If an error occurs in the processing of one of the five programs 1505-1509, the CurrentlyActive switch in the ControlTable 1400 is changed from a “Y” to an “R” to retry the program. If the retry is unsuccessful, the CurrentlyActive switch is changed from an “R” to an “S” signifying the table conversion has been suspended. The user will then have to look at the logs in the ../ds/tablename directory to see what the problem is that occurred, fix it, then run a program or some SQL code to change the CurrentlyActive switch from an “S” back to an “R”. If there is one table that needs the switch reset, the user can specify the table as a parameter. If all the suspended tables can be restarted, the parameter can be left off and all the switches that were an “S” will be changed back to an “R”. Once the table has its CurrentlyActive switch set back to an “R”, it will be the next table to be processed by the ds_driver program 1501.

Since the data conversion process occurs completely in background, a feedback program permits the user to check the status of what tables are currently going through the data standardization process. The feedback program shows the user how many total tables are in the data conversion process, how many have finished, how many are in progress, how many tables have not been started yet, and how many tables have been suspended. For each table that is suspended, the program lists the table name, the StatusIndicator, and which of the five programs 1505-1509 that the data conversion process executing. The user can take this information and look up the log file name in the ../ds/tablename directory and find out what the problem is and correct it.

Once all the tables have been through the data conversion process, the user can re-run the program that can re-set some of the database parameters to make the data conversion process run quicker and to increase performance for the next data conversion process. Preferably, the user backs up any system database tables and the database that went through the data conversion process before the database is opened up for public use.

FIG. 16 illustrates input modules 1601-1603 and a set up module 1604 having set up routines 1605-1609 for the method shown in FIG. 3, in accordance with a preferred embodiment of the present invention. More particularly, FIG. 16 illustrates a data conversion input 1601, a convert to tables module 1602, a conversion tables input 1603, a setup module 1604, an index/trigger table set up routine 1605, a control table set up routine 1606, a index/trigger file set up routine 1607, a SQL program set up routine 1608, and a user defined variables set up routine 1609. Preferably, the set up routines are run during step 302 in FIG. 3. Preferably, a computer program sets some of the database parameters to increase the performance of the data conversion process.

The data conversion input 1601 provides the old 205 and new 206 values for input into the conversion table 204. The convert-to-tables module 1602 combines the old 205 and new 206 values from the data conversion input 1601 with corresponding fields to produce the conversion table input 1603 having the conversion tables 204. Preferably, the computer 100 makes the conversion tables 204 with the field name as the prefix and “Cnv” as the suffix (e.g. ColorCnv). The setup module 1604 runs the five set up routines 1605-1609 responsive to receiving the conversion tables input 1603 having the conversion tables 204. The index/trigger table set up routine 1605 lists all of the indexes and triggers for each table being converted. The control table set up routine 1606 contains information about each table being converted. The index/trigger file set up routine 1607 creates a file for all the indices and triggers for each table being converted. The SQL program set up routine 1608 sets up the SQL program to convert each table being converted. The user-defined variables set up routine 1609 hold all of the user-defined variables (e.g., sysin ds_values).

More particularly, after the conversion tables have been set up successfully, the user executes another program (e.g., ds_setup) to set up the data conversion process. The program, ds_setup, prompts the user for conversion parameters, determines all the database tables 201 that contains the columns that need to be converted, save all triggers and indexes to separate files in case of a recovery, and create all the database SQL needed for each of the tables to do the data conversion process. The program prompts the user for the database to be converted, the database where copy tables 202 will reside, whether the user wants to keep the copy tables 202 around after the conversion for verification, the number of records to be converted at one time (the increment), and the maximum number of tables to convert at one time. The responses the user entered will have to be stored in a sysin ds_values so that it can be viewed (and some fields changed) later while the process is running. This file may be called sysin ds_values.

Once these user prompts have been entered, the ds_setup program performs the following five functions:

The conversion tables entered are checked for synonyms of the same user type, or datatype. For example, if a DoctorIDCnv was entered, the program will check that the user type of DoctorID and all those fields with a user type of DoctorID are changed as well (including ResponsibleDoctor, PerformingDoctor, and InterpretingDoctor). For each synonym field, a conversion table will be added with the user type defined of the primary field (e.g., a ResponsibleDoctorCnv, PerformingDoctorCnv, and InterpretingDoctorCnv is created with the same old value and new values contained in the DoctorIDCnv table). All these synonym tables will be added to the list of fields entered by the user.

The computer 100 creates the ControlTable 1400 list of fields that are cross-referenced with the database tables in the database the user specified. The ControlTable 1400 contains all the database tables that will be converted, as well as other fields such as: the size of the table, TotalRowcount, StartingPoint (i.e., the beginning point in the table where the fields are being converted), EndingPoint (i.e., the ending point in the table where the fields are being converted, or the StartingPoint plus the increment), and the StatusIndicator (where in the conversion process the table is at). Once the ControlTable 1400 has been created, all tables that have zero rows in the table are removed. The ControlTable 1400 is sorted in size order so that the smallest tables will be first in the table.

Save all the indexes and triggers to files called create_idx, drop_idx, create_trig, and drop_trig. The indexes and triggers are saved to the create files, but the SQL code to drop the indexes and the triggers are done in the drop_idx and drop_trig.

Create the IdxTrig database table. This table contains the names of the indexes and triggers and the tablenames they reside in.

Create all the SQL code needed for each table that is being converted and store it in a directory ../ds/tablename. The user may define what the high level directory could be named. Further, if the user wants to keep the copy tables 202 for verification, then a program may created to remove all the copy tables 202 when the verification is complete.

Examples of some of the features of the method 300 appear in the following SQL programs:

1. Example of a program for generating a conversion table 204 (see steps 1601-1603 in FIG. 16).

#>ConvertField

Enter the database that will be converted [def=Database1]:

Enter the database where the Conversion tables will reside [def=Database1]:

Enter the field to be converted (press enter to quit): Column1

The conversion table, Column1Cnv, already exists in this database. Do you want to delete the table?

y—delete Column1Cnv Table and start entering values in an empty Column1Cnv table.

n—append the data to be entered at the end of the existing Column1Cnv table. answer (y/n)[def=n]: y

NOTE: Column1 has a data type of varchar and length of 10.

Enter the old value of Column1 (press enter to stop): 8748555

Enter the new value of Column1: 6758885

Enter the old value of Column1 (press enter to stop): 2345332

Enter the new value of Column: 2345331

Enter the old value of Column1 (press enter to stop):

---------------------------------------------------------

Enter the next field to be converted (press enter to quit): Column2

NOTE: Column2 has a data type of varchar and length of 2.

Enter the old value of Column2 (press enter to stop): U

Enter the new value of Column2: N

Enter the old value of Column2 (press enter to stop): E

Enter the new value of Column2: M

Enter the old value of Column2 (press enter to stop):

---------------------------------------------------------

Enter the next field to be converted (press enter to quit):

Below are the contents of /ds/ConvertField_Discrepancies:

Table—Column3Cnv

These records have more than one oldvalue for the same newvalue. This can cause a problem in ds_verify, if there are multiple oldvalues for each newvalue. It will also cause duplicates to be created.

TABLE
Column4Cnv

| oldvalue | newvalue |
|---|---|
| 3 | 4 |
| 5 | 4 |

These records have more than one newvalue for the same oldvalue. This can cause a problem where two records will be put into the converted table for each newvalue.

Column5Cnv

| oldvalue | newvalue |
|---|---|
| 35366046 | 74038183 |
| 35366046 | 35366046 |
| 92915594 | 92915594 |
| 92915594 | 92915594 |

These records have more than one oldvalue for the same newvalue. This can cause a problem in ds_verify, if there are multiple oldvalues for each newvalue. It will also cause duplicates to be created.

| oldvalue | newvalue |
|---|---|
| 31310071 | 71048433 |
| 71048433 | 71048433 |
| 33476201 | 72623770 |
| 72623770 | 72623770 |
| 92915594 | 92915594 |
| 92915594 | 92915594 |

ConvertField ended successfully #>

2. Example of a program for converting a single original table 201 (see FIGS. 3 and 15).

The ds_setup program created SQL code that would be used for converting a single table. This SQL code is saved in a directory named after the table name. All SQL code that is created and run is temporarily stored in this directory, and if there is an error in the SQL code, it will not be deleted to permit the user to look at what occurred. The SQL code is the basis for the data conversion process. The particular table that is undergoing the data conversion process (e.g., Table1 table) is duplicated into a Copy table (CpTable1) with an identity column (called row_id). The original table 201 is cleared out, but not deleted. The SQL code is then run for each increment replacing the old value with the new value. The row count of the result and the return code are printed out and verified after the SQL code is run. The following SQL code provides an example of a program for converting a single table.

runisql<<EOF>/ds/Table1/ConvertTable1.log

use Database1

go

insert into Database1..Table1

select

CpTable1.TableColumn1,

CpTable1.TableColumn2,

isnull(Column1Cnv.newvalue,CpTable1.TableColumn3),

CpTable1.TableColumn4,

CpTable1.TableColumn5,

CpTable1.TableColumn6,

CpTable1.TableColumn7,

CpTable1.TableColumn8,

CpTable1.TableColumn9,

CpTable1.TableColumn10,

CpTable1.TableColumn11,

CpTable1.TableColumn12,

CpTable1.TableColumn13,

CpTable1.TableColumn14,

CpTable1.TableColumn15

from

Column1Cnv,

CpTable1

where

CpTable1.TableColumn3*=Column1Cnv.oldvalue

and CpTable1.row_id between 1 and 100000

go

print “%1! %2!”, @@error, @@rowcount

go

EOF

3. Example of a program for converting multiple original tables 201 (see FIGS. 3 and 15).

The ds_convert program 1502, 1503, and 1504, each shown in FIG. 15, runs the data conversion process. The ds_convert program 1502, 1503, and 1504 executes the program ds_table_conversion for each table that is to undergo the data conversion process. The ds_table_conversion then executes each of the five programs 1505-1509 for each table and waits for its completion. The ds_convert program 1502, 1503, and 1504 begins multiple versions of ds_table_conversion for each table, one each minute, until the maximum number of tables to convert (a user parameter) has been met. After this number has been met, another table will not start until one is complete. The ds_convert program 1502, 1503, and 1504 also determines if there is enough space left on the log segment and default segment to handle a new table, based on the calculations in the ControlTable 1400. For each minute, the display 118 shows the user how many more tables need to be converted. The following SQL code provides an example of a program for converting multiple original tables 201.

#>ds_convert

data standardization is beginning at 13:28:35

Processing table Table1.

NumLeftToConvert=16

ds_table_conversion: In ds_create_copy_table for table Table1 at 13:28:36

ds_table_conversion: In ds_drop_trig_idx for Table1 at 13:28:40

ds_table_conversion: In ds_convert_table for Table1 at 13:28:47

ds_table_conversion: In ds_create_trig_idx for Table1 at 13:28:50

ds_table_conversion: In ds_verify for Table1 at 13:28:58

ds_table_conversion: In cleanup for Table1 at 13:29:02

ds_table_conversion ended successfully for table Table1 at 13:29:03.

Processing table Table2.

NumLeftToConvert=15

ds_table_conversion: In ds_create_copy_table for table Table2 at 13:29:37

ds_table_conversion: In ds_drop_trig_idx for Table2 at 13:29:42

ds_table_conversion: In ds_convert_table for Table2 at 13:29:50

ds_table_conversion: In ds_create_trig_idx for Table2 at 13:29:54

ds_table_conversion: In ds_verify for Table2 at 13:30:05

ds_table_conversion: In cleanup for Table2 at 13:30:09

ds_table_conversion ended successfully for table Table2 at 13:30:11. Processing table Table3.

NumLeftToConvert=14

ds_table_conversion: In ds_create_copy_table for table Table3 at 13:30:36

ds_table_conversion: In ds_drop_trig_idx for Table3 at 13:30:41

ds_table_conversion: In ds_convert_table for Table3 at 13:30:49

ds_table_conversion: In ds_create_trig-idx for Table3 at 13:30:53

ds_table_conversion: In ds_verify for Table3 at 13:31:05

ds_table_conversion: In cleanup for Table3 at 13:31:09

ds_table_conversion ended successfully for table Table3 at 13:31:12.

Processing table Table4.

NumLeftToConvert=13

ds_table_conversion: In ds_create_copy_table for table Table4 at 13:32:37

ds_table_conversion: In ds_drop_trig_idx for Table4 at 13:32:52

ds_table_conversion: In ds_convert_table for Table4 at 13:33:04

ds_table_conversion: In ds_create_trig_idx for Table4 at 13:33:17

ds_table_conversion: In ds_verify for Table4 at 13:33:32

Processing table Table5.

NumLeftToConvert=13

ds_table_conversion: In ds_create_copy_table for table Table5 at 13:32:38

ds_table_conversion: In cleanup for Table4 at 13:33:45

ds_table_conversion: In ds_drop_trig_idx for Table5 at 13:33:45

ds_table_conversion ended successfully for table Table4 at 13:33:46.

ds_table_conversion: In ds_convert_table for Table5 at 13:34:06

ds_table_conversion: In ds_create_trig_idx for Table5 at 13:34:22

Processing table Table6.

NumLeftToConvert=12

ds_table_conversion: In ds_create_copy_table for table Table6 at 13:35:37

. . .

NumLeftToConvert=1

NumLeftToConvert=1

NumLeftToConvert=1

NumLeftToConvert=1

NumLeftToConvert=1

ds_table_conversion: In cleanup for Table16 at 17:22:35

ds_table_conversion ended successfully for table Table16 at 17:22:36

NumLeftToConvert=0

data standardization has completed at 17:22:39

#>

The present data conversion process is of particular use to businesses that use databases heavily and are in need of an efficient data conversion tool/methodology/process. Any businesses that have either large tables in the number of records or a large number of tables that have fields common to many tables that need to be converted would find the present data conversion process easier than doing a manual process. The present data conversion process saves a considerable amount of manual intervention and cuts down a data conversion job from weeks to less than a day.

More particularly, the present data conversion process for databases provides a safe, efficient, and flexible method to perform complicated mass updates to relational database tables with minimal user interaction. The data conversion process allows the concurrent conversion of multiple tables within the database, allows multiple from/to conversion specifications per column within table, identifies columns which are synonyms of specified conversion columns and automatically convert those columns as well, and performs multi-threaded table conversions to greatly enhance performance. Further, the data conversion process employs other database techniques to enhance performance, avoids database pitfalls that can occur during mass updates of data, and performs verification steps to ensure integrity of the conversion.

While the present invention has been described with reference to various illustrative embodiments thereof, the present invention is not intended that the invention be limited to these specific embodiments. Those skilled in the art will recognize that variations, modifications and combinations of the disclosed subject matter can be made without departing from the spirit and scope of the invention as set forth in the appended claims.

What is claimed is:

1. A method for converting data in a database from a current value to a different replacement value, comprising the steps of:
receiving information identifying a database data field to be updated and data comprising a current value and corresponding replacement value for replacing existing data in said identified data field;
examining said database to determine whether said data field is associated with at least one of,
(a) a trigger for initiating amendment of a database element upon alteration of said data field content, and
(b) an index used for locating said data field;
disabling a trigger and an index when identified by said examination;
replacing said existing data in said data field with said received replacement value; and
verifying successful replacement of said data field current value.

2. A method according to claim 1, including the step of:
restoring a disabled trigger and index, in response to replacement of said data field current value.

3. A method according to claim 1, including the step of:
comparing said existing data in said identified data field with said received current value and replacing said existing data in said data field with said received replacement value in response to a substantial match between said existing data and said received current value.

4. A method according to claim 1, including the steps of:
identifying a plurality of additional data fields containing data of similar data type as said data in said identified data field based on at least one of, (a) a data type synonym search and (b) use of a data field cross-reference map, and
replacing existing data in said plurality of additional data fields with received replacement values.

5. A method according to claim 4, wherein
said data fields comprise different database table columns of data, and
said cross-reference map identifies whether a database table column is used in another location in said database.

6. A method according to claim 4, wherein
said step of replacing existing data in said plurality of additional data fields is responsive to a parameter identifying at least one of, (a) a number of data field rows to be replaced, (b) a maximum number of database tables to be processed and (c) a status indicator identifying a status of a database.

7. A method according to claim 4, including the step of:
employing a control table containing database table characteristics concerning progress of data replacement.

8. A method according to claim 4, including the step of:
creating an SQL (Structured Query Language) compatible data element comprising said received current value and said corresponding replacement value and a database table containing said plurality of additional data fields to receive said replacement values.

9. A method according to claim 4, including the step of:
creating a data element containing items identifying an index and a trigger for said plurality of additional data fields to receive said replacement values.

10. A method according to claim 4, including the step of:
limiting a rate at which said data fields are provided for update to ensure at least one of, (a) data update resources are not exceeded and (b) a predetermined update rate limit is not exceeded.

11. A method according to claim 4, wherein
said identified data fields to receive replacement values are grouped, and including the step of:
employing scheduling information for scheduling said groups of data fields for update.

12. A method according to claim 11, wherein
said groups of data fields comprise at least one database table.

13. A method according to claim 4, including the step of:
generating a status indicator determining progress of individual steps involved in replacing values of said identified additional data fields.

14. A method according to claim 4, wherein
said identified data fields to receive replacement values comprise a database table and including the step of:
creating a copy of said database table to receive replacement values including a column identifying a sequences of rows in said database table.

15. A method according to claim 14, including the steps of:
processing said identified data fields to receive replacement values one row at a time,
verifying successful replacement of individual data fields by row.

16. A method according to claim 14, including the step of:
identifying duplicate rows, and
processing duplicate rows differently.

17. A user interface system for use in converting data in a database from a current value to a different replacement value, comprising the steps of:
initiating generation of at least one display image supporting,
receiving information identifying a database data field to be updated and data comprising a current value and corresponding replacement value for replacing existing data in said identified data field;
initiating processing comprising,
examining said database to determine whether said data field is associated with at least one of,
(a) a trigger for initiating amendment of a database element upon alteration of said data field content, and
(b) an index used for locating said data field;
disabling a trigger and index when identified by said examination;
replacing said existing data in said data field with said received replacement value; and
viewing an updated data field.
